(19) United States
(12) Patent Application Publication
(10) Pub. No.: US 2025/0089802 A1
(43) Pub. Date: Mar. 20, 2025

(54) AEROSOL GENERATING DEVICE INCLUDING TEMPERATURE SENSOR

(71) Applicant: KT&G CORPORATION, Daejeon (KR)

(72) Inventors: Chul Ho JANG, Bucheon-si (KR); Gyoung Min GO, Daejeon (KR); Jangwon SEO, Daejeon (KR); Jin Chul JUNG, Daejeon (KR)

(73) Assignee: KT&G CORPORATION, Daejeon (KR)

(21) Appl. No.: 18/565,947

(22) PCT Filed: May 19, 2023
(86) PCT No.: PCT/KR2023/006817

§ 371 Date: Nov. 30, 2023

(30) Foreign Application Priority Data
Jun. 2, 2022 (KR) 10-2022-0067553
Jul. 26, 2022 (KR) 10-2022-0092231

(51) Int. Cl. A24F 40/51; A24F 40/05; A24F 40/42; B06B 1/06

(52) U.S. Cl. CPC A24F 40/51; A24F 40/05; A24F 40/42; B06B 1/0655; B06B 2201/55; B06B 2201/77

(57) ABSTRACT

An aerosol generating device includes a main body including a cartridge fastening area, a cartridge detachably fastened to the cartridge fastening area, and a temperature sensor positioned to face the cartridge fastening area in the main body and including an infrared sensor, wherein the cartridge includes a reservoir configured to store an aerosol generating material, a transmission member configured to receive the aerosol generating material from the reservoir, a vibrator assembly configured to atomize the aerosol generating material by vibrating the transmission member, a housing configured to accommodate the reservoir, the transmission member, and the vibrator assembly and including a sensor hole formed at a position opposite to the temperature sensor, and a lens positioned between the sensor hole and the temperature sensor.

### TECHNICAL FIELD

The following embodiments relate to an aerosol generating device including a temperature sensor.

### BACKGROUND ART

Recently, the demand for alternative articles to overcome the disadvantages of traditional cigarettes has increased. For example, there is an increasing demand for devices that generate an aerosol by electrically heating a cigarette stick (e.g., cigarette-like electronic cigarettes). Accordingly, research on an electrically heated aerosol generating device and a cigarette stick (or an aerosol generating article) applied thereto is being actively conducted.

### DISCLOSURE OF THE INVENTION

### Technical Goals

Various embodiments provide an aerosol generating device including an ultrasonic atomizer for generating an aerosol, and are intended to measure the accurate temperature of a vibrator in real time to prevent damage to the vibrator or performance deterioration of the vibrator as the vibrator is overheated due to various factors such as the absence of a means for controlling the temperature of the vibrator in the ultrasonic atomizer or errors in a temperature sensing function.

### Technical Solutions

According to an embodiment, an aerosol generating device includes a main body including a cartridge fastening area, a cartridge detachably fastened to the cartridge fastening area, and a temperature sensor positioned to face the cartridge fastening area in the main body and including an infrared sensor, wherein the cartridge may include a reservoir configured to store an aerosol generating material, a transmission member configured to receive the aerosol generating material from the reservoir, a vibrator assembly configured to atomize the aerosol generating material by vibrating the transmission member, a housing configured to accommodate the reservoir, the transmission member, and the vibrator assembly and including a sensor hole formed at a position opposite to the temperature sensor, and a lens positioned between the sensor hole and the temperature sensor.

In an embodiment, the vibrator assembly may include a vibrator including a first surface facing the transmission member and a second surface opposite to the first surface, and a support assembly configured to support the vibrator and including a channel that is open from the lens to the second surface of the vibrator.

In an embodiment, the channel may be an open space such that the lens directly faces the second surface of the vibrator.

In an embodiment, the second surface of the vibrator, the channel, the lens, and the temperature sensor may be arranged on one straight line.

In an embodiment, the support assembly may include a cartridge substrate spaced apart from the vibrator and including a first opening formed at a position opposite to the lens, and a support structure positioned between the cartridge substrate and the second surface of the vibrator and including a second opening communicating with the first opening and the second surface, wherein the channel may include the first opening and the second opening.

In an embodiment, the support assembly may include a first electrode body configured to contact the first surface of the vibrator, and a second electrode body configured to contact the second surface of the vibrator and provide an elastic force onto the second surface.

In an embodiment, the second electrode body may be positioned in the second opening of the support structure and include an elastic material having an open center which overlaps at least a portion of the second opening.

In an embodiment, the lens may be spaced apart from the vibrator assembly and the temperature sensor, and an area between the lens and the vibrator assembly and an area between the lens and the temperature sensor may each be an open space.

In an embodiment, the lens may be configured to condense light traveling from the vibrator assembly toward the temperature sensor to be concentrated on the temperature sensor.

In an embodiment, the lens may include a first lens surface facing the vibrator assembly, and a second lens surface opposite to the first lens surface and facing the temperature sensor.

In an embodiment, the lens may include a first condensing area formed to be curved with a predetermined curvature, so as to condense light traveling from the first lens surface to the second lens surface.

In an embodiment, the first condensing area may be formed on the second lens surface, and the first lens surface may be substantially flat.

In an embodiment, the lens may include a second condensing area formed to protrude from the second lens surface and have an inclined distal portion, so as to condense the light traveling from the first lens surface to the second lens surface.

In an embodiment, the second condensing area may surround the center of the second lens surface.

In an embodiment, the second condensing area may be formed in plurality, and the plurality of second condensing areas may be arranged around a center of the second lens surface and spaced apart from each other at predetermined intervals in a radial direction.

### Effects

According to an embodiment, an aerosol generating device including a temperature sensor may sense a change in the temperature of a vibrator in real time and precisely using the temperature sensor by forming a substantially open space from the rear surface of the vibrator through a lens to the temperature sensor, and control the driving of the vibrator based on the sensed temperature change, thereby preventing the vibrator from being overheated.

The effects of the aerosol generating device including the temperature sensor according to an embodiment may not be limited to the above-mentioned effects, and other unmentioned effects may be clearly understood from the following description by one of ordinary skill in the art.

### BRIEF DESCRIPTION OF DRAWINGS

FIG. 1 is a block diagram of an aerosol generating device according to an embodiment.

FIG. 2 is a diagram schematically illustrating an aerosol generating device according to an embodiment.

FIG. 3a is a perspective view of an aerosol generating device according to an embodiment, showing a closed state of a mouthpiece.

FIG. 3b is a perspective view of an aerosol generating device according to an embodiment, showing an open state of a mouthpiece.

FIG. 4 is an exploded perspective view of a cartridge according to an embodiment.

FIG. 5a is a perspective view of a vibrator assembly according to an embodiment.

FIG. 5b is an exploded perspective view of a vibrator assembly according to an embodiment.

FIG. 6a is a cross-sectional view of an aerosol generating device according to an embodiment.

FIG. 6b is an enlarged cross-sectional view of an aerosol generating device according to an embodiment.

FIG. 7 is a rear perspective view of an aerosol generating device according to an embodiment.

### BEST MODE FOR CARRYING OUT THE INVENTION

The terms used in various embodiments are selected from among common terms that are currently widely used, in consideration of their function in the disclosure. However, the terms may become different according to an intention of one of ordinary skill in the art, a precedent, or the advent of new technology. Also, in particular cases, the terms are discretionally selected by the applicant of the disclosure, and the meaning of those terms will be described in detail in the corresponding part of the detailed description. Therefore, the terms used in the disclosure are not merely designations of the terms, but the terms are defined based on the meaning of the terms and content throughout the disclosure.

It will be understood that when a certain part “includes” a certain component, the part does not exclude another component but may further include another component, unless the context clearly dictates otherwise. Also, terms such as “unit,” “module,” etc., as used in the specification may refer to a part for processing at least one function or operation and which may be implemented as hardware, software, or a combination of hardware and software.

As used herein, an expression such as “at least one of” that precedes listed components modifies not each of the listed components but all the listed components. For example, the expression “at least one of a, b, or c” should be construed as including a, b, c, a and b, a and c, b and c, or a, b, and c.

In various embodiments, the term “aerosol generating article” may refer to an article that accommodates a medium, in which an aerosol passes through the article and the medium is transferred. A representative example of the aerosol generating article may be a cigarette. However, the scope of the disclosure is not limited thereto.

In various embodiments, the terms “upstream” or “upstream direction” may refer to a direction away from a mouth of a user (smoker), and the terms “downstream” or “downstream direction” may refer to a direction toward the mouth of the user. The terms “upstream” and “downstream” may be used to describe relative positions of components of an aerosol generating article.

In various embodiments, the term “puff” refers to inhalation by a user, and inhalation refers to a situation in which a user draws in an aerosol into his or her oral cavity, nasal cavity, or lungs through the mouth or nose.

In an embodiment, an aerosol generating device may be a device that generates an aerosol by electrically heating a cigarette accommodated in an inner space.

In an embodiment, the aerosol generating device may include a heater. In an embodiment, the heater may be an electrically resistive heater. For example, the heater may include an electrically conductive track, and the heater may be heated as a current flows through the electrically conductive track.

In an embodiment, the heater may include a tubular heating element, a plate-shaped heating element, a needle-shaped heating element, or a rod-shaped heating element, and may heat the inside or outside of the cigarette according to the shape of a heating element.

In an embodiment, the cigarette may include a tobacco rod and a filter rod. The tobacco rod may be formed as a sheet or a strand, or may be formed of tobacco leaves finely cut from a tobacco sheet. Also, the tobacco rod may be surrounded by a thermally conductive material. For example, the thermally conductive material may be a metal foil such as aluminum foil. However, embodiments are not limited thereto.

In an embodiment, the filter rod may be a cellulose acetate filter. The filter rod may include at least one segment. For example, the filter rod may include a first segment that cools an aerosol and a second segment that filters a predetermined ingredient contained in the aerosol.

In an embodiment, the aerosol generating device may be a device that generates an aerosol using a cartridge containing an aerosol generating material.

In an embodiment, the aerosol generating device may include a cartridge containing the aerosol generating material and a main body supporting the cartridge. The cartridge may be detachably coupled to the main body. However, embodiments are not limited thereto. The cartridge may be integrally formed or assembled with the main body, and may be secured to the main body so as not to be detached by a user. The cartridge may be mounted on the main body while the aerosol generating material is accommodated therein. However, embodiments are not limited thereto. The aerosol generating material may be injected into the cartridge while the cartridge is coupled to the main body.

In an embodiment, the cartridge may hold the aerosol generating material having any one of various states, such as a liquid state, a solid state, a gaseous state, and a gel state. The aerosol generating material may include a liquid composition. For example, the liquid composition may be a liquid including a tobacco-containing material having a volatile tobacco flavor ingredient, or a liquid including a non-tobacco material.

In an embodiment, the cartridge may be operated by an electrical signal or a wireless signal transmitted from the main body to perform the function of generating an aerosol by converting the phase of the aerosol generating material inside the cartridge to a gaseous phase. The aerosol may refer to a gas in which vaporized particles generated from the aerosol generating material are mixed with air.

In various embodiments, the aerosol generating device may generate an aerosol by heating the liquid composition, and the generated aerosol may pass through the cigarette and be delivered to the user. That is, the aerosol generated from the liquid composition may travel along airflow paths of the aerosol generating device, and the airflow paths may be configured to allow the aerosol to pass through the cigarette and be delivered to the user.

In various embodiments, the aerosol generating device may be a device that generates an aerosol from the aerosol generating material using an ultrasonic vibration manner. In this case, the ultrasonic vibration manner may refer to a manner of generating an aerosol by atomizing the aerosol generating material with ultrasonic vibration generated by a vibrator.

In an embodiment, the aerosol generating device may include a vibrator, and may generate vibration at short intervals through the vibrator to atomize the aerosol generating material. The vibration generated by the vibrator may be ultrasonic vibration, and the frequency band of the ultrasonic vibration may be from about 100 kHz to about 3.5 MHz. However, embodiments are not limited thereto.

In an embodiment, the aerosol generating device may further include a wick that absorbs the aerosol generating material. For example, the wick may be disposed to surround at least one area of the vibrator or may be disposed to contact at least one area of the vibrator.

In an embodiment, as a voltage (e.g., an alternating voltage) is applied to the vibrator, the vibrator may generate heat and/or ultrasonic vibration, and the heat and/or ultrasonic vibration generated by the vibrator may be transmitted to the aerosol generating material absorbed in the wick. The aerosol generating material absorbed in the wick may be converted into a gas phase by the heat and/or ultrasonic vibration transmitted from the vibrator, and consequently, an aerosol may be generated.

For example, the viscosity of the aerosol generating material absorbed in the wick may be lowered by the heat generated by the vibrator, and the aerosol generating material whose viscosity is lowered may change to fine particles by the ultrasonic vibration generated by the vibrator, so that an aerosol may be generated. However, embodiments are not limited thereto.

In various embodiments, the aerosol generating device may be a device that generates an aerosol by heating the aerosol generating article accommodated therein in an induction heating manner.

In an embodiment, the aerosol generating device may include a susceptor and a coil. In an embodiment, the coil may apply a magnetic field to the susceptor. As the aerosol generating device supplies power to the coil, a magnetic field may be formed inside the coil. In an embodiment, the susceptor may be a magnetic body that generates heat by an external magnetic field. As the susceptor is positioned inside the coil and generates heat with the magnetic field applied, the aerosol generating article may be heated. Also, optionally, the susceptor may be positioned in the aerosol generating article.

In various embodiments, the aerosol generating device may further include a cradle.

In an embodiment, the aerosol generating device and the separate cradle may form a system together. For example, the cradle may be used to charge a battery of the aerosol generating device. Alternatively, a heater may be heated when the cradle and the aerosol generating device are coupled to each other.

Hereinafter, embodiments of the disclosure will be described in detail with reference to the accompanying drawings such that one of ordinary skill in the art may easily practice the disclosure. The disclosure may be practiced in forms that are implementable in the aerosol generating devices according to various embodiments described above or may be embodied and practiced in many different forms and is not limited to the embodiments described herein.

Hereinafter, embodiments of the disclosure will be described in detail with reference to the drawings.

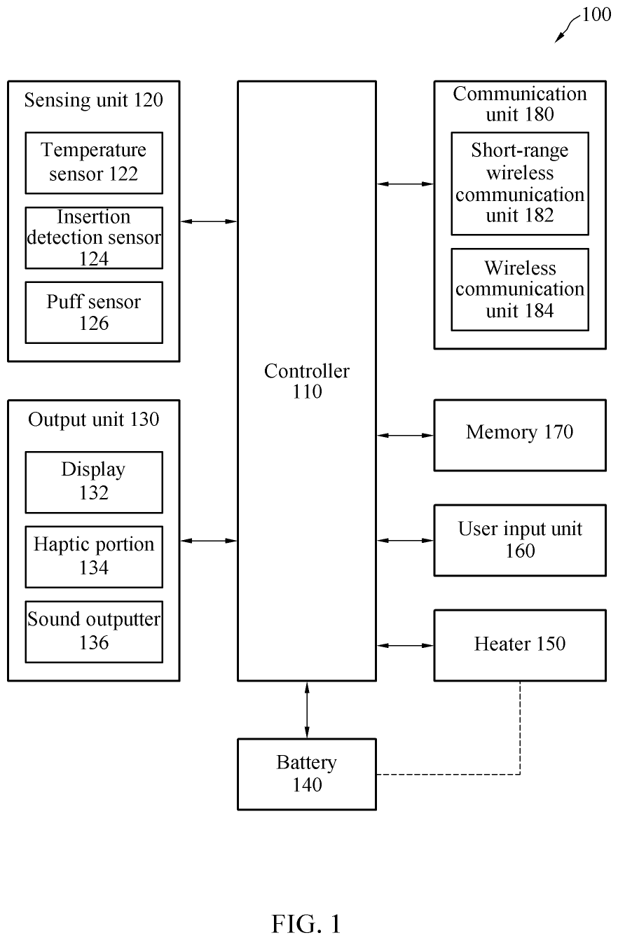

FIG. 1 is a block diagram of an aerosol generating device 100 according to an embodiment.

The aerosol generating device 100 may include a controller 110, a sensing unit 120, an output unit 130, a battery 140, a heater 150, a user input unit 160, a memory 170, and a communication unit 180. However, an internal structure of the aerosol generating device 100 is not limited to what is shown in FIG. 1. It is to be understood by one of ordinary skill in the art to which the disclosure pertains that some of the components shown in FIG. 1 may be omitted or new components may be added according to the design of the aerosol generating device 100.

In an embodiment, the sensing unit 120 may sense a state of the aerosol generating device 100 or a state of an environment around the aerosol generating device 100, and transmit sensing information obtained through the sensing to the controller 110. Based on the sensing information, the controller 110 may control the aerosol generating device 100 to control operations of the heater 150, restrict smoking, determine whether an aerosol generating article (e.g., an aerosol generating article, a cartridge, etc.) is inserted, display a notification, and perform other functions.

In an embodiment, the sensing unit 120 may include at least one of a temperature sensor 122, an insertion detection sensor 124, or a puff sensor 126. However, embodiments are not limited thereto.

In an embodiment, the temperature sensor 122 may sense a temperature at which the heater 150 (or an aerosol generating material) is heated. The aerosol generating device 100 may include a separate temperature sensor for sensing the temperature of the heater 150, or the heater 150 itself may perform a function as a temperature sensor. Alternatively, the temperature sensor 122 may be arranged around the battery 140 to monitor the temperature of the battery 140.

In an embodiment, the insertion detection sensor 124 may sense whether the aerosol generating article is inserted and/or removed. The insertion detection sensor 124 may include, for example, at least one of a film sensor, a pressure sensor, a light sensor, a resistive sensor, a capacitive sensor, an inductive sensor, or an infrared sensor, which may sense a signal change by the insertion and/or removal of the aerosol generating article.

In an embodiment, the puff sensor 126 may sense a puff from a user based on various physical changes in an airflow path or airflow channel. For example, the puff sensor 126 may sense the puff from the user based on any one of a temperature change, a flow change, a voltage change, and a pressure change.

In an embodiment, the sensing unit 120 may further include at least one of a temperature/humidity sensor, an atmospheric pressure sensor, a magnetic sensor, an acceleration sensor, a gyroscope sensor, a position sensor (e.g., a global positioning system (GPS)), a proximity sensor, or a red, green, blue (RGB) sensor (e.g., an illuminance sensor), in addition to the sensors 122 through 126 described above. A function of each sensor may be intuitively inferable from its name by one of ordinary skill in the art, and thus, a more detailed description thereof will be omitted here.

In an embodiment, the output unit 130 may output information about the state of the aerosol generating device 100 and provide the information to the user. The output unit 130 may include at least one of a display 132, a haptic portion 134, or a sound outputter 136. However, embodiments are not limited thereto. When the display 132 and a touchpad are provided in a layered structure to form a touchscreen, the display 132 may be used as an input device in addition to an output device.

In an embodiment, the display 132 may visually provide information about the aerosol generating device 100 to the user. The information about the aerosol generating device 100 may include, for example, a charging/discharging state of the battery 140 of the aerosol generating device 100, a preheating state of the heater 150, an insertion/removal state of the aerosol generating article, a limited usage state (e.g., an abnormal article detected) of the aerosol generating device 100, or the like, and the display 132 may externally output the information. The display 132 may be, for example, a liquid-crystal display panel (LCD), an organic light-emitting display panel (OLED), or the like. The display 132 may also be in the form of a light-emitting diode (LED) device.

In an embodiment, the haptic portion 134 may provide information about the aerosol generating device 100 to the user in a haptic way by converting an electrical signal into a mechanical stimulus or an electrical stimulus. The haptic portion 134 may include, for example, a motor, a piezoelectric element, or an electrical stimulation device.

In an embodiment, the sound outputter 136 may provide information about the aerosol generating device 100 to the user in an auditory way. For example, the sound outputter 136 may convert an electric signal into a sound signal and externally output the sound signal.

In an embodiment, the battery 140 may supply power to be used to operate the aerosol generating device 100. The battery 140 may supply power to heat the heater 150. In addition, the battery 140 may supply power required for operations of the other components (e.g., the sensing unit 120, the output unit 130, the user input unit 160, the memory 170, and the communication unit 180) included in the aerosol generating device 100. The battery 140 may be a rechargeable battery or a disposable battery. The battery 140 may be, for example, a lithium polymer (LiPoly) battery. However, embodiments are not limited thereto.

In an embodiment, the heater 150 may receive power from the battery 140 to heat the aerosol generating material. Although not shown in FIG. 1, the aerosol generating device 100 may further include a power conversion circuit (e.g., a direct current (DC)-to-DC (DC/DC) converter) that converts power of the battery 140 and supplies the power to the heater 150. In addition, when the aerosol generating device 100 generates an aerosol in an induction heating manner, the aerosol generating device 100 may further include a DC-to-alternating current (AC) (DC/AC) converter that converts DC power of the battery 140 into AC power.

In an embodiment, the controller 110, the sensing unit 120, the output unit 130, the user input unit 160, the memory 170, and the communication unit 180 may receive power from the battery 140 to perform functions. Although not shown in FIG. 1, the aerosol generating device 100 may further include a power conversion circuit, for example, a low dropout (LDO) circuit or a voltage regulator circuit, which converts power of the battery 140 and supplies the power to respective components.

In an embodiment, the heater 150 may be formed of a predetermined electrically resistive material that is suitable. For example, the electrically resistive material may be a metal or a metal alloy including, for example, titanium, zirconium, tantalum, platinum, nickel, cobalt, chromium, hafnium, niobium, molybdenum, tungsten, tin, gallium, manganese, iron, copper, stainless steel, nichrome, or the like. However, embodiments are not limited thereto. In addition, the heater 150 may be implemented as a metal heating wire, a metal heating plate on which an electrically conductive track is arranged, a ceramic heating element, or the like. However, embodiments are not limited thereto.

According to an embodiment, the heater 150 may be an induction heater. For example, the heater 150 may include a susceptor that heats the aerosol generating material by generating heat through a magnetic field applied by a coil.

In an embodiment, the heater 150 may include a plurality of heaters. For example, the heater 150 may include a first heater for heating the aerosol generating article and a second heater for heating a liquid.

In an embodiment, the user input unit 160 may receive information input from the user or may output information to the user. For example, the user input unit 160 may include a keypad, a dome switch, a touchpad (e.g., a contact capacitive type, a pressure resistive film type, an infrared sensing type, a surface ultrasonic conduction type, an integral tension measurement type, a piezo effect method, etc.), a jog wheel, a jog switch, or the like. However, embodiments are not limited thereto. In addition, although not shown in FIG. 1, the aerosol generating device 100 may further include a connection interface such as a universal serial bus (USB) interface, and may be connected to another external device through the connection interface such as a USB interface to transmit and receive information or to charge the battery 140.

In an embodiment, the memory 170, which is hardware for storing various pieces of data processed in the aerosol generating device 100, may store data processed by the controller 110 and data to be processed thereby. The memory 170 may include at least one type of storage medium of a flash memory type memory, a hard disk type memory, a multimedia card micro type memory, a card type memory (e.g., an SD or XD memory), a random access memory (RAM), a static random access memory (SRAM), a read-only memory (ROM), an electrically erasable programmable read-only memory (EEPROM), a programmable read-only memory (PROM), a magnetic memory, a magnetic disk, or an optical disk. The memory 170 may store an operating time of the aerosol generating device 100, a maximum number of puffs, a current number of puffs, at least one temperature profile, data associated with a smoking pattern of the user, or the like. In an embodiment, the communication unit 180 may include at least one component

for communicating with another electronic device. For example, the communication unit 180 may include a short-range wireless communication unit 182 and a wireless communication unit 184.

In an embodiment, the short-range wireless communication unit 182 may include a Bluetooth communication unit, a BLE communication unit, a near field communication unit, a WLAN (Wi-Fi) communication unit, a ZigBee communication unit, an infrared data association (IrDA) communication unit, a Wi-Fi direct (WFD) communication unit, an ultra-wideband (UWB) communication unit, and an Ant+ communication unit. However, embodiments are not limited thereto.

In an embodiment, the wireless communication unit 184 may include, for example, a cellular network communicator, an Internet communicator, a computer network (e.g., a local area network (LAN) or a wide-area network (WAN)) communicator, or the like. However, embodiments are not limited thereto. The wireless communication unit 184 may use subscriber information (e.g., international mobile subscriber identity (IMSI)) to identify and authenticate the aerosol generating device 100 in a communication network.

In an embodiment, the controller 110 may control the overall operation of the aerosol generating device 100. In an embodiment, the controller 110 may include at least one processor. The processor may be implemented as an array of a plurality of logic gates, or may be implemented as a combination of a general-purpose microprocessor and a memory in which a program executable by the microprocessor is stored. In addition, it is to be understood by those having ordinary skill in the art to which the present disclosure pertains that it may be implemented in other types of hardware.

In an embodiment, the controller 110 may control the temperature of the heater 150 by controlling the supply of power from the battery 140 to the heater 150. For example, the controller 110 may control the supply of power by controlling switching of a switching element between the battery 140 and the heater 150. In another example, a direct heating circuit may control the supply of power to the heater 150 according to a control command from the controller 110.

In an embodiment, the controller 110 may analyze a sensing result obtained by the sensing of the sensing unit 120 and control processes to be performed thereafter. For example, the controller 110 may control power to be supplied to the heater 150 to start or end an operation of the heater 150 based on the sensing result obtained by the sensing unit 120. As another example, the controller 110 may control an amount of power to be supplied to the heater 150 and a time for which the power is to be supplied, such that the heater 150 may be heated up to a predetermined temperature or maintained at a desired temperature, based on the sensing result obtained by the sensing unit 120.

In an embodiment, the controller 110 may control the output unit 130 based on the sensing result obtained by the sensing unit 120. For example, when the number of puffs counted through the puff sensor 126 reaches a preset number, the controller 110 may inform the user that the aerosol generating device 100 is to be ended soon, through at least one of the display 132, the haptic portion 134, or the sound outputter 136.

In an embodiment, the controller 110 may control a power supply time and/or a power supply amount for the heater 150 according to a state of the aerosol generating article sensed by the sensing unit 120. For example, when the aerosol generating article is in an over-humidified state, the controller 110 may control the power supply time for an inductive coil to increase a preheating time, compared to a case where the aerosol generating article is in a general state.

An embodiment may also be implemented in the form of a recording medium including instructions executable by a computer, such as a program module executable by the computer. A computer-readable medium may be any available medium that can be accessed by a computer and includes a volatile medium, a non-volatile medium, a removable medium, and a non-removable medium. In addition, the computer-readable medium may include both a computer storage medium and a communication medium. The computer storage medium includes all of a volatile medium, a non-volatile medium, a removable medium, and a non-removable medium implemented by any method or technology for storage of information such as computer-readable instructions, data structures, program modules or other data. The communication medium typically includes computer-readable instructions, data structures, other data in modulated data signals such as program modules, or other transmission mechanisms, and includes any information transfer medium.

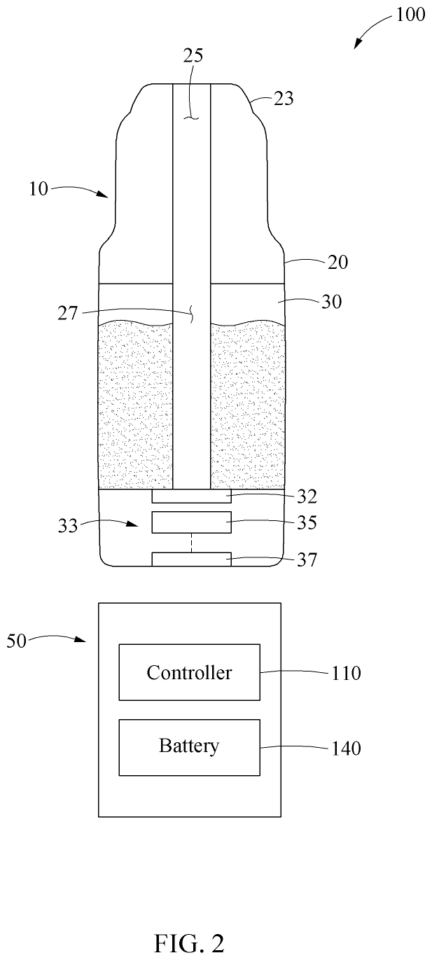

FIG. 2 is a diagram schematically illustrating the aerosol generating device 100 according to an embodiment.

Referring to FIG. 2, the aerosol generating device 100 according to an embodiment may include a cartridge 10 and a main body 50. Some components of the aerosol generating device 100 described below with reference to FIG. 2 may be substantially the same as or similar to some components of the aerosol generating device 100 described above with reference to FIG. 1, and a duplicate description will be omitted below.

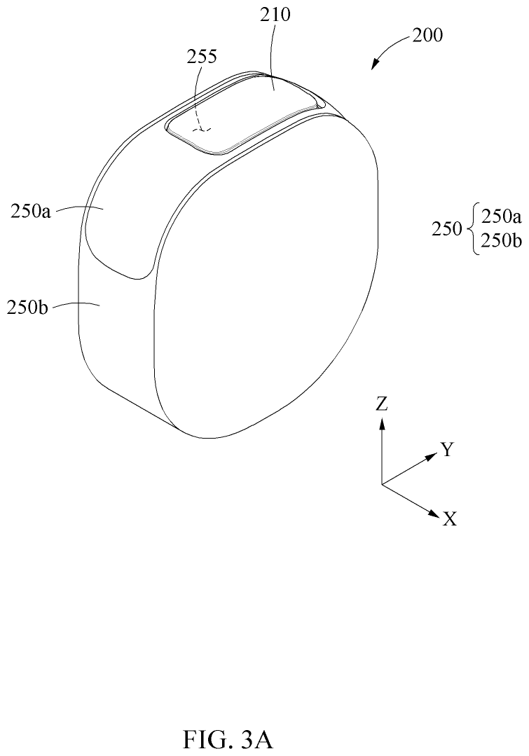

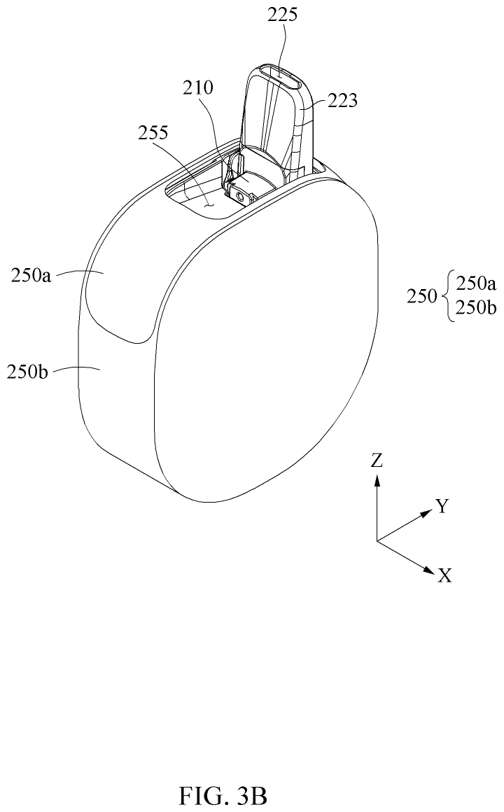

In an embodiment, the cartridge 10 may accommodate an aerosol generating material and may be detachably fastened to the main body 50. For example, at least a portion of the cartridge 10 may be inserted into the main body 50 (e.g., a cartridge fastening area 255 of FIG. 3a), whereby the cartridge 10 and the main body 50 may be connected. Embodiments are limited thereto, and at least a portion of the main body 50 may be inserted into the cartridge 10, whereby the cartridge 10 and the main body 50 may be connected. The cartridge 10 and the main body 50 may be fastened to each other in various methods, such as screw fastening, magnetic fastening, fit fastening, or snag-fit fastening.

In an embodiment, the cartridge 10 may include at least one of a reservoir 30, a transmission member 32, and a vibrator assembly 33, and may include a housing 20 for accommodating these components therein.

In an embodiment, the housing 20 may form the exterior of the cartridge 10, and may accommodate at least a portion of the components for driving the aerosol generating device 100 therein.

In an embodiment, the structure and shape of the housing 20 may be implemented in various manners. For example, as shown in FIG. 2, the housing 20 may be formed in the shape of a column or stick, but embodiments are not limited thereto. The housing 20 may include a mouthpiece 23 and an aerosol flow path 27.

In an embodiment, the mouthpiece 23 may be directly or indirectly connected to a body of a user of the aerosol generating device 100. The mouthpiece 23 may include an intake 25 communicating with the inside of the cartridge 10, specifically, the aerosol flow path 27.

For example, the user may inhale an aerosol generated by the aerosol generating device 100 by bringing the mouth into contact with the mouthpiece 23. When the user inhales through the mouthpiece 23, the pressure in the intake 25 and the aerosol flow path 27 may decrease. Accordingly, the aerosol inside the cartridge 10 may be delivered to the user through the aerosol flow path 27 and the intake 25.

In an embodiment, the reservoir 30 may be positioned in the inner space of the housing 20 and may accommodate the aerosol generating material. For example, the reservoir 30 may store the aerosol generating material and may provide the aerosol generating material to another component (e.g., the transmission member 32). The reservoir 30 may be supplied with the aerosol generating material from the outside.

In an embodiment, the aerosol generating material may be a material in various phases such as liquid, solid, gas, or gel, or may be a material in a mixed phase thereof.

In an embodiment, the aerosol generating material may be a liquid including a volatile tobacco flavor ingredient and/or a tobacco-containing material. For example, the aerosol generating material may include at least one of water, a solvent, ethanol, a plant extract, a fragrance, a flavoring agent, and a vitamin mixture. Alternatively, the aerosol generating material may include at least one of menthol, peppermint, spearmint oil, and fruit flavor.

In an embodiment, the transmission member 32 may receive the aerosol generating material from the reservoir 30. The transmission member 32 may be directly or indirectly connected to the reservoir 30, and at least a partial area thereof may face the aerosol flow path 27. The transmission member 32 may include at least one of cotton, ceramic, glass, and a porous material, or may structurally include a flow path through which the aerosol generating material flows. For example, the transmission member 32 may be a wick including a hygroscopic or porous material.

In an embodiment, the vibrator assembly 33 may be positioned inside the housing 20 and vibrate the transmission member 32. The vibrator assembly 33 may include a vibrator 35 and a cartridge substrate 37 (e.g., printed circuit board) for controlling the driving of the vibrator 35.

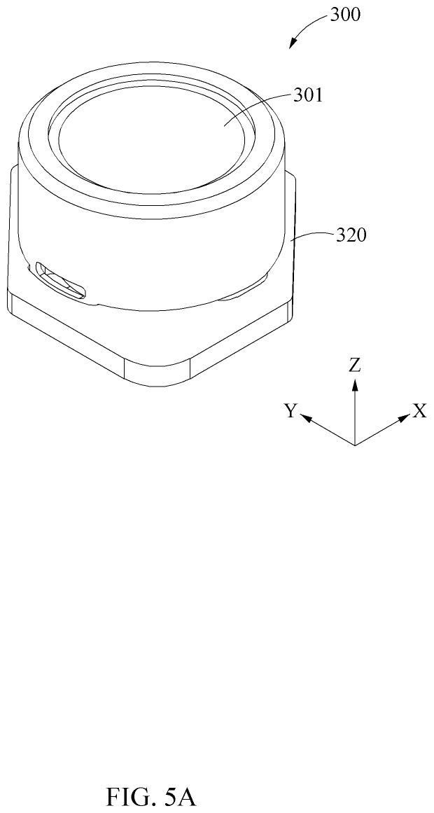

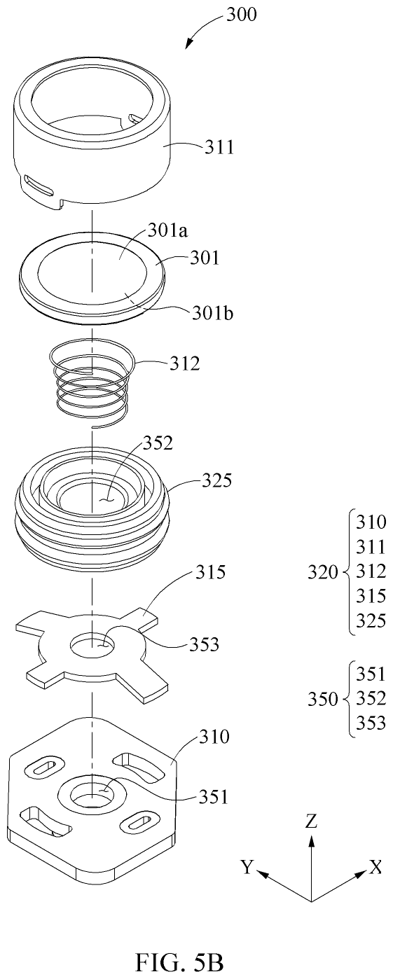

For example, the vibrator assembly 33, along with other components (e.g., a partial area of the housing 20 and/or the transmission member 32) in certain embodiments, may act as an atomizer. A detailed structure of the vibrator assembly 33 according to an embodiment will be described below with reference to FIG. 5a.

In an embodiment, the vibrator assembly 33 may generate vibration at relatively short intervals, such as ultrasonic vibration. For example, the frequency of ultrasonic vibration may be about 100 kHz to 3.5 MHz. The aerosol generating material transmitted from the reservoir 30 to the transmission member 32 may be vaporized and/or atomized into an aerosol by the vibration of the vibrator assembly 33.

In an embodiment, the main body 50 may accommodate a controller (e.g., the controller 110 of FIG. 1) for controlling the driving of the aerosol generating device 100, a battery (e.g., the battery 140 of FIG. 1), and other components (e.g., at least one of the sensing unit 120, the output unit 130, the memory 170, and the communication unit 180 of FIG. 1).

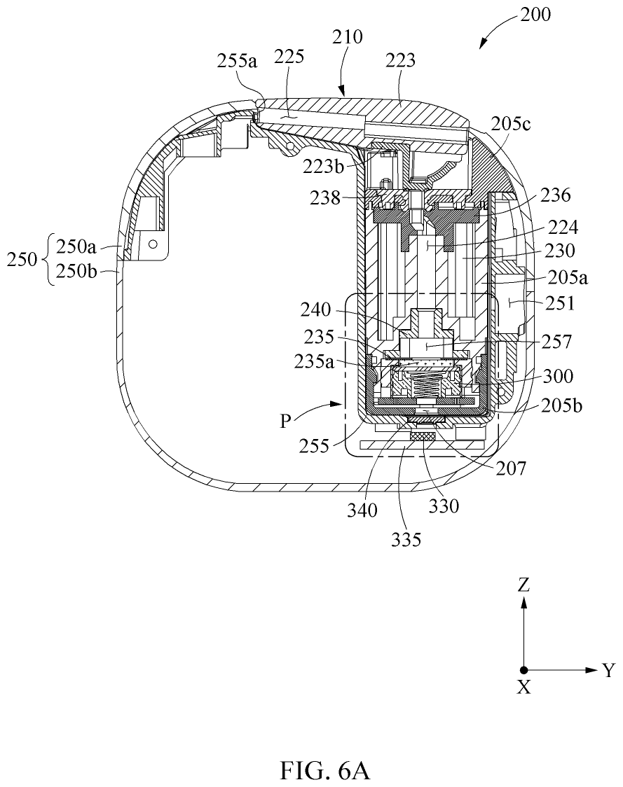

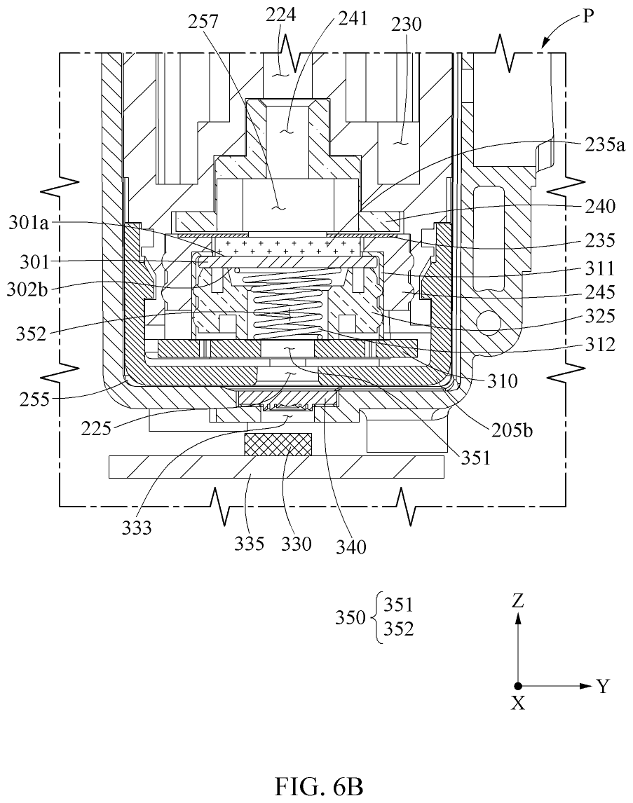

In an embodiment, the main body 50 may be electrically or communicatively connected to the cartridge substrate 37 to supply data and/or power thereto. Although FIG. 2 illustrates the controller 110 and the cartridge substrate 37 separately as an example, embodiments are not limited thereto. For example, the cartridge substrate 37 may be included as part of the controller 110, and the main body 50 may further include a main body substrate (e.g., a main body substrate 335 of FIG. 6a), which is another component of the controller 110.

FIG. 3a is a perspective view of an aerosol generating device 200 according to an embodiment, showing a closed state of a mouthpiece 223. FIG. 3b is a perspective view of the aerosol generating device 200, showing an open state of the mouthpiece 223.

Referring to FIGS. 3a and 3b, the aerosol generating device 200 (e.g., the aerosol generating device 100 of FIGS. 1 or 2) according to an embodiment may include a cartridge 210 (e.g., the cartridge 10 of FIG. 2) and a main body 250 (e.g., the main body 50 of FIG. 2).

The aerosol generating device 200 and the components thereof shown in FIG. 3a are one of the implementable examples of the aerosol generating device 100 described above with reference to FIGS. 1 and 2, and embodiments are not limited thereto in practical implementation. The aerosol generating device 200 may be implemented in various structures and shapes. Hereinafter, in describing the aerosol generating device 200, the description provided above will not be repeated.

In an embodiment, the main body 250 may include a first body 250a and a second body 250b. The first body 250a and the second body 250b may be secured and fastened to each other, and each of the first body 250a and the second body 250b may accommodate and protect the internal components of the aerosol generating device 200.

In an embodiment, the first body 250a may include the cartridge fastening area 255, and may support the cartridge 210 when the cartridge 210 is fastened to the cartridge fastening area 255. For example, the cartridge fastening area 255 may include an opening formed on a surface of the first body 250a facing one direction (e.g., +Z direction), and the cartridge 210 may be inserted into the opening and fastened to the cartridge fastening area 255.

In an embodiment, the second body 250b may be fastened to the first body 250a. The second body 250b may be an area for a user to grip the aerosol generating device 200. Although not shown in the drawing, at least one of a temperature sensor (e.g., the temperature sensor 122 of FIG. 1) and a substrate (e.g., the controller 110 of FIGS. 1 or 2) may be accommodated inside the second body 250b. In the drawings, the second body 250b is shown as having a substantially circular or polygonal shape, but is not limited thereto in practical implementation, and may be implemented in the shape of a column or stick, for example.

In an embodiment, the cartridge 210 may include the mouthpiece 223. The mouthpiece 223 may be rotated or tilted based on an axis of rotation, and based on the rotation or tilting, an intake 225 (e.g., the intake 25 of FIG. 2) of the mouthpiece 223 may be selectively exposed.

For example, as shown in FIG. 3a, when the aerosol generating device 200 is not in use, the mouthpiece 223 may be positioned inside the cartridge fastening area 255, and the intake 225 may not be exposed to the outside of the aerosol generating device 200.

For example, as shown in FIG. 3b, the user may rotate or tilt the mouthpiece 223 to use the aerosol generating device 200, and thus the intake 225 may be exposed to the outside of the aerosol generating device 200.

As shown in FIGS. 3a and 3b, the aerosol generating device 200 may cover the intake 225 as necessary, so that the aerosol generating device 200 may prevent an external foreign substance from entering the cartridge 210 through the intake 225, and prevent the intake 225 from being contaminated. Also, the aerosol or aerosol generating material is prevented from leaking from the cartridge 210 to the outside of the aerosol generating device 200.

However, the method of driving the mouthpiece 223 of FIGS. 3a and 3b is merely an example, and is not limited thereto in practical implementation. The mouthpiece 223 may be implemented in various manners. For example, the main body 250 or the cartridge 210 may include a separate door to selectively expose the intake 225 of the cartridge 210.

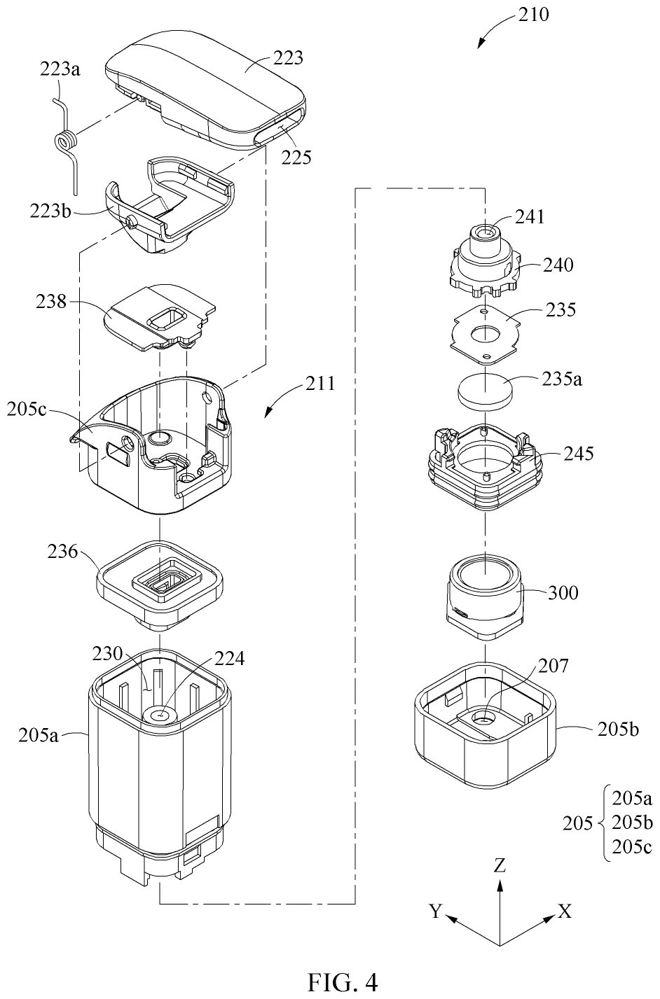

FIG. 4 is an exploded perspective view of the cartridge 210 according to an embodiment.

Referring to FIG. 4, in an embodiment, the cartridge 210 may include a cartridge body 211 and the mouthpiece 223.

The aerosol generating device 100 shown in FIG. 4 may be an example of the aerosol generating device 100 described above or a modified example thereof, and a duplicate description will be omitted below.

In an embodiment, the cartridge body 211 may include a housing 205, a transmission member 235, and a vibrator assembly 300.

In an embodiment, the mouthpiece 223 may be coupled or connected to the cartridge body 211 to be movable with respect to the cartridge body 211. The components of the cartridge 210 according to an embodiment are not limited to the example described above, and components may be added, or some components may be omitted according to embodiments.

In an embodiment, the housing 205 may form the overall exterior of the cartridge 210, while also forming an inner space for accommodating at least portion of the components of the cartridge 210 (e.g., a reservoir 230, the transmission member 235, and/or the vibrator assembly 300).

In an embodiment, the structure and shape of the housing 205 may be implemented in various manners. For example, the housing 205 may be formed in the shape of a column or stick, but is not limited thereto. Although only the embodiment of the housing 205 of the cartridge 210 having the shape of a rectangular column on the whole is shown in the drawing, but in another embodiment (not shown), the housing 205 may be formed in the shape of a cylindrical column or another polygonal column (e.g., a triangular pillar or a pentagonal pillar) on the whole other than the rectangular column.

In an embodiment, the housing 205 may include a first housing 205a, a second housing 205b connected to one area of the first housing 205a, and a third housing 205b connected to another area of the first housing 205a.

For example, the second housing 205b may be coupled to one area positioned at a lower end (e.g., the end portion in the −z direction) of the first housing 205a, and an inner space may be formed between the first housing 205a and the second housing 205b so that the components of the cartridge 210 may be disposed therein.

In an embodiment, the third housing 205c may be coupled to one area positioned at an upper end (e.g., the end portion in the +z direction) of the first housing 205a, and at least a portion of the mouthpiece 223 may be disposed on one side of the third housing 205c.

In an embodiment, the first housing 205a and the second housing 205b may be coupled to each other to form an aerosol flow path 224 through which an airflow (e.g., air or an aerosol) moves inside the cartridge body 211. For example, the first housing 205a may form a portion of the aerosol flow path 224, and the second housing 205b may form the remaining portion of the aerosol flow path 224.

In an embodiment, the first housing 205a and the second housing 205b may be coupled to form an inner space, and various components necessary for the operation of the cartridge 210, such as the vibrator assembly 300 and the transmission member 235, may be accommodated or disposed in the inner space.

In an embodiment, the first housing 205a and the second housing 205b may protect the components accommodated in the inner space, and the third housing 205c may protect the mouthpiece 223 and other components coupled or connected to the mouthpiece 223. The housing 205 may form at least a portion of the aerosol flow path 224, or at least a portion of the structure of the housing 205 may function as an inner wall of the aerosol flow path 224.

In an embodiment, the housing 205 may include a sensor hole 207. The sensor hole 207 may be formed in a partial area of the second housing 205b of the housing 205. For example, the sensor hole 207 may be positioned in a bottom surface of the second housing 205b where the cartridge 210 is coupled to the main body 250. The sensor hole 207 may be formed at a position opposite to (i.e., facing) a temperature sensor (e.g., a temperature sensor 330 of FIG. 6a). The sensor hole 207 will be described with reference to FIG. 6a and so on.

In an embodiment, the mouthpiece 223 may be a portion that contacts the mouth of the user, and the mouthpiece 223 may be disposed in or coupled to one area of the housing 205. For example, the mouthpiece 223 may be connected to the third housing 205c.

In an embodiment, the mouthpiece 223 may move between an open position and a closed position. The cartridge 210 may further include an elastic body 223a for providing an elastic force to the mouthpiece 223. For example, the elastic body 223a may elastically support the mouthpiece 223 toward the open position.

In an embodiment, the elastic body 223a may be disposed on or around the axis of rotation of the mouthpiece 223. The mouthpiece 223 may move from the closed position to the open position by the elastic force of the elastic body 223a. The elastic body 223a may be manufactured using a metal material (e.g., SUS).

In an embodiment, the mouthpiece 223 may rotate about the axis of rotation, and the elastic body 223a may be a torsion spring positioned on the axis of rotation of the mouthpiece 223. The elastic body 223a may relatively greatly deform when the mouthpiece 223 is in the closed position, and relatively less deform when the mouthpiece 223 is in the open position. Accordingly, the mouthpiece 223 may be provided with a biased elastic force to rotate from the closed position to the open position.

In an embodiment, the mouthpiece 223 may include the intake 225 for discharging the aerosol generated inside the cartridge 210 to the outside of the cartridge 210. For example, one side of the intake 225 may be connected to the outside, and the other side thereof may be connected to the aerosol flow path 224 in the open position. The user may bring the mouth into contact with the mouthpiece 223 and be supplied with the aerosol discharged to the outside through the intake 225 of the mouthpiece 223.

In an embodiment, the mouthpiece 223 may be rotatably or tiltably coupled to the third housing 205c together with a support portion 223b. The support portion 223b may be disposed between the mouthpiece 223 and the third housing 205c and surround at least a portion of the bottom (i.e., the side facing the −z direction) of the mouthpiece 223.

In an embodiment, the mouthpiece 223, the support portion 223b, and the third housing 205c may be connected to each other by the axis of rotation. Accordingly, the mouthpiece 223 may be firmly coupled to the third housing 205c and may rotate with respect to the third housing 205c to move between the open position and the closed position.

In an embodiment, the aerosol atomized by the vibrator assembly 300 may be discharged to the outside of the cartridge 210 through the aerosol flow path 224 and supplied to the user. For example, the aerosol generated by a vibrator (e.g., the vibrator 301 of FIG. 6b) of the vibrator assembly 300 may flow along the aerosol flow path 224 which provides fluid communication between an atomization space (e.g., an atomization space 257 of FIG. 6a) and the intake 225 of the mouthpiece 223, and then be discharged to the outside of the cartridge 210 through the intake 225.

In an embodiment, the aerosol flow path 224 may be connected to the mouthpiece 223 along the internal structure of the second housing 205b and the first housing 205a. For example, the airflow moving in a forward direction along the aerosol flow path 224 may move in predetermined directions (e.g., sequentially in +z direction, a direction transverse to the z-axis, −z direction, the direction transverse to the z-axis, and then +z direction).

In an embodiment, the intake 225 may be a passage inside of the mouthpiece 223. The intake 225 may be connected to the aerosol flow path 224 when the mouthpiece 223 is in the open position. The intake 225 may be disconnected from the aerosol flow path 224 when the mouthpiece 223 is in the closed position.

In an embodiment, the reservoir 230 may be disposed inside the first housing 205a, and an aerosol generating material may be stored in the reservoir 230. For example, a liquid aerosol generating material may be stored in the reservoir 230. However, embodiments are not limited thereto.

In an embodiment, the transmission member 235 may be positioned between the reservoir 230 and the vibrator 301 of the vibrator assembly 300. The aerosol generating material stored in the reservoir 230 may be supplied to the vibrator assembly 300 through the transmission member 235.

In an embodiment, the transmission member 235 may deliver the aerosol generating material from the reservoir 230 to the vibrator 301. For example, the transmission member 235 may absorb the aerosol generating material in the reservoir 230, and the aerosol generating material absorbed in the transmission member 235 may be transmitted to the vibrator assembly 300.

In an embodiment, the transmission member 235 may be disposed adjacent to the reservoir 230 to receive the liquid aerosol generating material from the reservoir 230. For example, the aerosol generating material stored in the reservoir 230 may be discharged to the outside of the reservoir 230 through a liquid supply port (not shown) formed in one area of the reservoir 230 facing the transmission member 235, and the transmission member 235 may absorb at least a portion of the aerosol generating material discharged from the reservoir 230, thereby absorbing the aerosol generating material from the reservoir 230.

In an embodiment, the cartridge 210 may be configured such that one or more components cover at least a portion of the vibrator 301 of the vibrator assembly 300 where an aerosol is generated. In an embodiment, the cartridge 210 may further include an absorber 235a that transmits the absorbed aerosol generating material to the vibrator assembly 300.

In an embodiment, the absorber 235a may be a separate component of the cartridge 210 which is connected to the transmission member 235. Alternatively, transmission member 235 may include the absorber 235a. However, embodiments are not limited thereto.

In an embodiment, the absorber 235a may be manufactured using a material capable of absorbing an aerosol generating material. For example, the absorber 235a may include at least one material of SPL 30(H), SPL 50(H) V, NP 100(V8), SPL 60(FC), and melamine.

In an embodiment where the cartridge 210 further includes the absorber 235a, the aerosol generating material may be absorbed not only in the transmission member 235 but also in the absorber 235a. Accordingly, the absorption amount of aerosol generating material may improve.

In an embodiment, the transmission member 235 may include a material that has a higher absorption rate of aerosol generating material than the absorber 235a. In this case, the aerosol generating material absorbed in the transmission member 235 may be controlled to be supplied at a uniform rate to the vibrator 301 by the absorber 235a having a relatively low absorption rate. Accordingly, it may be prevented that an excessively large amount of aerosol generating material is provided to the vibrator 301.

In an embodiment, the absorber 235a may be disposed to cover at least a portion of the vibrator 301, serving as a physical barrier to prevent “spitting” of particles that are not sufficiently atomized during the aerosol generating process from being discharged directly to the outside of the aerosol generating device 200. Here, “spitting” may refer to the discharge of relatively large-sized particles of an aerosol generating material that are not sufficiently atomized to the outside of the cartridge 210. As the cartridge 210 further includes the absorber 235a, the possibility of spitting may be reduced, and the smoking satisfaction of the user may improve.

In an embodiment, the absorber 235a may be positioned between the transmission member 235 and one surface of the vibrator 301 where an aerosol is generated, and may deliver the aerosol generating material from the transmission member 235 to the vibrator 301.

For example, one area of the absorber 235a may contact one area of the transmission member 235 facing one direction (e.g., −z direction), and another area of the absorber 235a may contact one area of the vibrator 301 of the vibrator assembly 300 facing one direction (e.g., +z direction). That is, the absorber 235a may be positioned on a top surface (e.g., a surface in the +z direction or a first surface 301a of FIG. 5b) of the vibrator 301, and transmit the aerosol generating material absorbed by the transmission member 235 to the vibrator assembly 300.

In an embodiment, the transmission member 235, the absorber 235a, and the vibrator assembly 300 may be sequentially disposed in the longitudinal direction (e.g., z-axis direction) of the cartridge 210 or the housing 205. Also, the absorber 235a and the transmission member 235 may be sequentially stacked on the vibrator 301.

At least a portion of the aerosol generating material supplied from the reservoir 230 to the transmission member 235 through the above-described arrangement structure may move to the absorber 235a contacting the transmission member 235, and further move along the absorber 235a to an area adjacent to the vibrator assembly 300.

In an embodiment, the aerosol generating material may be stably transmitted to the vibrator assembly 300, such that the vibrator assembly 300 may continuously generate a uniform amount of aerosol, and the arrangement structure described above may implement a physical dual barrier that prevents the above-described spitting by the transmission member 235 and the absorber 235a.

In an embodiment, although the drawings show only an embodiment in which the cartridge 210 includes one transmission member 235 and one absorber 235a, the cartridge 210 according to another embodiment may include more of the transmission member 235 and/or the absorber 235a. Alternatively, the transmission member 235 and the absorber 235a may be implemented as one body.

In an embodiment, the cartridge 210 may further include a support plate 315 for grounding the cartridge substrate 310 and/or firmly coupling the cartridge substrate 310 to the second housing 205b. The support plate 315 may be positioned between the second housing 205b and the cartridge substrate 310 to reinforce the coupling between the cartridge substrate 310 and the second housing 205b.

In an embodiment, the support plate 315 may be disposed between the support structure 325 and the cartridge substrate 310, and at least a portion of the support plate 315 may be fastened to the cartridge substrate 310 to support the support structure 325. The support plate 315 may reinforce the fastening force between the cartridge substrate 310 and the first electrode body 311.

In an embodiment, the support plate 315 may include a flat area and an inclined area having an inclination with respect to the flat area so that the inclined area is fastened to a fastening recess (not shown). The flat area and the inclined area of the support plate 315 may be integrally formed with an elastic material so that when the inclined area is pressured toward the flat area, restoring force due to elasticity acts.

In an embodiment, the cartridge 210 may further include a hollow portion 240 to prevent the aerosol generating material from leaking from the reservoir 230 into the aerosol flow path 224. In an embodiment, as at least a portion of the aerosol flow path 224 may be surrounded by the reservoir 230. In this regard, if the aerosol generating material leaks from the reservoir 230 into the aerosol flow path 224, the smoking satisfaction of the user may decrease.

In an embodiment, the hollow portion 240 may seal a gap around the liquid supply port of the reservoir 230 (e.g., a gap between the liquid supply port and the transmission member 235). Accordingly, in the cartridge 210 according to an embodiment, the hollow portion 240 may prevent the aerosol generating material in the reservoir 230 from leaking into the aerosol flow path 224, thereby preventing a decrease in the smoking satisfaction of the user.

In an embodiment, the hollow portion 240 may be positioned in the atomization space 257 of the housing 205 to prevent the aerosol generating material in the reservoir 230 from leaking into the aerosol flow path 224. For example, the hollow portion 240 may include a bore having a circular shape. The hollow portion 240 may fit into the inside of the first housing 205a and come into close contact with an outer wall of the reservoir 230.

In an embodiment, since the hollow portion 240 has a bore therein, the hollow portion 240 may form a portion of the aerosol flow path 224 through which the aerosol generated from the vibrator 301 moves, while preventing the aerosol generating material from flowing from the reservoir 230 into the aerosol flow path 224.

In an embodiment, the hollow portion 240 may include at least one bore connected to the aerosol flow path 224. For example, the hollow portion 240 may include a hollow portion opening 241 on a top surface (e.g., a surface in the +z direction).

In an embodiment, the hollow portion opening 241 may be formed so that the aerosol generated in the atomization space 257 may move to the aerosol flow path 224. For example, the hollow portion opening 241 may be formed at a portion of the hollow portion 240 where the atomization space 257 meets the aerosol flow path 224, and the aerosol that is generated in the atomization space 257 and flows in one direction (e.g., +z direction) may move toward the mouthpiece 223 through the hollow portion opening 241.

In an embodiment, the hollow portion 240 may include a material having elasticity (e.g., rubber) to absorb ultrasonic vibration generated from the vibrator 301. Accordingly, the transmission of ultrasonic vibration from the vibrator 301 to the user through the housing 205 of the cartridge 210 may be minimized.

In an embodiment, the hollow portion 240 may be positioned at the upper end of the transmission member 235 and press the transmission member 235 in a direction toward the vibrator 301, thereby maintaining the contact between the transmission member 235 and the vibrator 301. For example, the hollow portion 240 may maintain the contact between the absorber 235a and the vibrator 301 by pressing the transmission member 235 and/or the absorber 235a in one direction (e.g., −z direction).

The cartridge 210 according to an embodiment may further include a waterproof member 245 for maintaining the position of the transmission member 235 and/or the vibrator 301 inside the first housing 205a.

The waterproof member 245 may be disposed to surround at least a portion of outer surface of the transmission member 235, the absorber 235a, and/or the vibrator 301, thereby accommodating the transmission member 235, the absorber 235a, and/or the vibrator 301.

In an embodiment, the waterproof member 245 may be disposed between the first housing 205a and the second housing 205b, so that the transmission member 235, the absorber 235a, and/or the vibrator 301 may be maintained or secured in an area between the first housing 205a and the second housing 205b.

In an embodiment, the waterproof member 245 may be coupled to the first housing 205a by at least a portion of the waterproof member 245 being fit into the first housing 205a by interference fit, but the method of coupling the first housing 205a and the waterproof member 245 is not limited to the example described above. In another example, the first housing 205a and the waterproof member 245 may be coupled by at least one method of the snap-fit method, screw coupling method, or magnetic coupling method.

In an embodiment, the waterproof member 245 may include a material (e.g., silicone or rubber) having a predetermined rigidity and waterproofness to secure the transmission member 235 and the vibrator 301 to the first housing 205a and to prevent the aerosol generating material from leaking from the reservoir 230. For example, the waterproof member 245 may seal an area between the reservoir 230 and the transmission member 235 or the vibrator 301, thereby preventing leakage of the aerosol generating material.

In an embodiment, like the hollow portion 240, the waterproof member 245 may include a material (e.g., rubber) having elasticity to absorb ultrasonic vibration generated from the vibrator 301.

In an embodiment, the cartridge 210 may further include a first sealing body 236 for maintaining the coupling between the first housing 205a and the third housing 205c and sealing the reservoir 230.

In an embodiment, the first sealing body 236 may be disposed between the first housing 205a and the third housing 205c. For example, the first sealing body 236 may be coupled to the upper end of the first housing 205a and the lower end of the third housing 205c, thereby firmly maintaining the coupling between the first housing 205a and the third housing 205c.

In an embodiment, the first sealing body 236 may include a structure that seals the reservoir 230 while not sealing the aerosol flow path 224. For example, the first sealing body 236 may have a structure that includes a hole in a portion where the aerosol flow path 224 is positioned and does not include a hole in a portion where the reservoir 230 is positioned, in a state of being coupled to the top of the first housing 205a. Accordingly, the first sealing body 236 may separate or isolate the reservoir 230 from the aerosol flow path 224 at the upper end of the first housing 205a without blocking the aerosol flow path 224.

In an embodiment, the cartridge 210 may further include a second sealing body 238 coupled to the third housing 205c to seal the periphery of the aerosol flow path 224. The second sealing body 238 may be coupled to an upper end of the third housing 205c. The second sealing body 238 may include a hole having a size corresponding to that of the aerosol flow path 224 to seal the periphery of a portion where the aerosol flow path 224 and the intake 225 are connected without blocking the aerosol flow path 224.

In an embodiment, the cartridge 210 may include both the first sealing body 236 and the second sealing body 238.

In an embodiment, the first sealing body 236 and the second sealing body 238 may be coupled to the upper and lower ends of the third housing 205c, respectively, and at least a portion of the first sealing body 236 and the second sealing body 238 may be partially coupled to each other in the third housing 205c. Accordingly, the first housing 205a and the third housing 205c may be more firmly coupled via the first sealing body 236 and the second sealing body 238.

In an embodiment, the first sealing body 236 and the second sealing body 238 may be coupled to the first housing 205a and/or the third housing 205c in a manner of interference fit, but the method of coupling the sealing body 236 and the second sealing body 238 is not limited to the example described above.

In an embodiment, the first sealing body 236 and the second sealing body 238 may include a material (e.g., silicone) having a predetermined rigidity and waterproofness to be firmly coupled to the first housing 205a and/or the third housing 205c and function as a part of the inner wall of the aerosol flow path 224.

For example, in the process of atomizing the aerosol generating material by the vibrator 301, a portion of the aerosol generating material may not be sufficiently atomized and droplets with relatively large particles may be generated. Also, droplets may be generated as a portion of the atomized aerosol is liquefied inside an airflow path. The generated droplets may block the aerosol flow path 224, leak to the outside of the cartridge 210 through another path (e.g., an inlet 251 of FIG. 6a), or leak to the outside of the mouthpiece 223 through the intake 225, which may decrease the convenience and smoking satisfaction of the user. The first sealing body 236 and the second sealing body 238 may prevent these problems and provide convenience and smoking satisfaction to the user.

FIG. 5a is a perspective view of a vibrator assembly 300 according to an embodiment, and FIG. 5b is an exploded perspective view of the vibrator assembly 300 according to an embodiment.

Referring to FIGS. 5a and 5b, the vibrator assembly 300 according to an embodiment may include at least one of the vibrator 301, the first electrode body 311, a second electrode body 312, the support structure 325, the support plate 315, and the cartridge substrate 310.

In an embodiment, the vibrator assembly 300 may atomize the aerosol generating material by vibrating the transmission member 235. The vibrator assembly 300 may include the vibrator 301 and a support assembly 320.

In an embodiment, the support assembly 320 may refer to the components supporting the vibrator 301 or may refer to the components other than the vibrator 301 in the vibrator assembly 300. For example, the support assembly 320 may include at least one of the cartridge substrate 310, the first electrode body 311, the second electrode body 312, the support plate 315, and the support structure 325.

In an embodiment, the vibrator 301 may generate an aerosol by atomizing the liquid aerosol generating material by vibrating the transmission member 235. The vibrator 301 may include the first surface 301a facing the transmission member 235, and a second surface 301b opposite to the first surface 301a.

In an embodiment, the vibrator 301 may include a piezoelectric ceramic. The piezoelectric ceramic may be a functional material that generates electricity when applied with force and generates force when applied with electricity, thereby performing conversion between electricity and force. For example, the vibrator 301 may generate vibration at short intervals by the applied electricity, and the vibration may vaporize the aerosol generating material and/or change the aerosol generating material into particles.

In an embodiment, the vibrator 301 may generate ultrasonic vibration. The frequency of the ultrasonic vibration generated by the vibrator 301 may be about 100 kHz to 10 MHz, and preferably about 100 kHz to 3.5 MHz.

In an embodiment, as the vibrator 301 generates ultrasonic vibration of a corresponding frequency band, the vibrator 301 may vibrate in the longitudinal direction (e.g., z-axis direction) of the cartridge 210 or the housing 205. However, the direction in which the vibrator 301 according to an embodiment of the present disclosure vibrates is not limited thereto, and the direction in which the vibrator vibrates may be changed to various directions (e.g., one of the x-axis direction, the y-axis direction, and the z-axis direction or a combination thereof).

In an embodiment, the vibrator 301 may atomize the aerosol generating material in an ultrasonic manner, thereby generating an aerosol at a relatively low temperature compared to a manner of heating the aerosol generating material. For example, in the manner of heating the aerosol generating material using a heater, the aerosol generating material may be unintentionally heated to a temperature of 200 degrees Celsius or higher, and the user may feel a burnt taste in the aerosol.

In contrast, the cartridge 210 according to an embodiment may atomize the aerosol generating material in an ultrasonic manner, thereby generating an aerosol in the temperature range of about 100 to 160 degrees Celsius, which is a relatively low temperature compared to the manner of heating the aerosol generating material using a heater. Accordingly, the burnt taste in the aerosol may be reduced, and the smoking satisfaction of the user may improve.

In an embodiment, the vibrator 301 may be electrically connected to an external power source through the cartridge substrate 310, and may generate ultrasonic vibration by the power supplied from the external power source. For example, as the vibrator 301 is electrically connected to the cartridge substrate 310 positioned inside the cartridge 210, and the cartridge substrate 310 is electrically connected to the main body 250, the vibrator 301 may receive power from a battery (e.g., the battery 140 of FIGS. 1 or 2).

In an embodiment, the aerosol may be generated in the atomization space 257 that is positioned above the first surface 301a of the vibrator 301 and communicates with the aerosol flow path 224. When the user inhales through the opened mouthpiece 223, the aerosol generated in the atomization space 257 may be mixed with external air introduced along the aerosol flow path 224 and move in a direction toward the intake 225.

In an embodiment, the atomization space (e.g., the atomization space 257 of FIG. 6a) may be positioned above the first surface 301a of the vibrator 301 facing the aerosol flow path 224, such that the atomization space 257 and the aerosol flow path 224 may communicate with each other. The cartridge 210 may have a straight aerosol discharge path so that the generated aerosol may be easily discharged to the outside of the cartridge 210.

In an embodiment, the vibrator 301 may be electrically connected to the cartridge substrate 310 through the first electrode body 311 and the second electrode body 312.

In an embodiment, the first electrode body 311 may include a material (e.g., metal) having electrical conductivity, and may contact the first surface 301a of the vibrator 301 and electrically connect the vibrator 301 and the cartridge substrate 310.

In an embodiment, the first electrode body 311 may have a tubular shape to accommodate at least a portion of the outer circumferential surface of the vibrator 301. An opening may be formed in one portion of the first electrode body 311 so that at least a portion of the vibrator 301 (e.g., the first surface 301a) may be exposed to the outside of the first electrode body 311.

For example, one portion (e.g., an upper end portion) of the first electrode body 311 may be arranged to surround at least one area of the outer circumferential surface of the vibrator 301 and contact the vibrator 301, and another portion (e.g., a lower end portion) of the first electrode body 311 may be formed to extend from the one portion in a direction toward the cartridge substrate 310 and contact one area of the cartridge substrate 310. The contact structure of the first electrode body 311 described above may allow the vibrator 301 to be electrically connected to the cartridge substrate 310.

In an embodiment, the first electrode body 311 may have an opening so that at least a portion of the vibrator 301 may be exposed to the outside of the first electrode body 311. A partial area of the first surface 301a of the vibrator 301 that is exposed to the outside of the first electrode body 311 through the opening of the first electrode body 311 may contact the transmission member 235 and/or the absorber 235a and atomize the aerosol generating material in the transmission member 235 and/or the absorber 235a.

In an embodiment, the second electrode body 312 may include a material having electrical conductivity, and may be positioned on the second surface 301b of the vibrator 301 or between the vibrator 301 and the cartridge substrate 310 to electrically connect the vibrator 301 and the cartridge substrate 310.

For example, as one end of the second electrode body 312 contacts the second surface 301b of the vibrator 301, and the other end thereof contacts the partial area of the cartridge substrate 310 facing the vibrator 301, and thus the vibrator 301 may be electrically connected to the cartridge substrate 310.

In an embodiment, the second electrode body 312 may contact the second surface 301b of the vibrator 301 and press the vibrator 301 in a direction that the first surface 301a of the vibrator 301 faces (e.g., +z direction). The second electrode body 312 may have elasticity and support the vibrator 301 by being compressed between the support structure 325 and the other surface of the vibrator 301.

In an embodiment, the second electrode body 312 may include a conductive material having elasticity, and may serve to electrically connect the vibrator 301 and the cartridge substrate 310. Also, the second electrode body 312 may serve to provide an elastic force to the vibrator 301 in a direction of the second surface 301b and support the vibrator 301.

For example, the second electrode body 312 may include a conductive spring, but the second electrode body 312 is not limited to the embodiment described above.

In an embodiment, the cartridge 210 may include the support structure 325 positioned between the second surface 301b of the vibrator 301 and the cartridge substrate 310 to support the second electrode body 312.

In an embodiment, the support structure 325 may be disposed inside the first electrode body 311 to support the vibrator 301. At least a portion of the support structure 325 may be surrounded by the first electrode body 311, and at least a portion of the support structure 325 may be coupled to the first electrode body 311 in an interference fit manner.

In an embodiment, the support structure 325 may include, for example, a material (e.g., silicone or rubber) having elasticity, and may be disposed to surround the second electrode body 312, thereby elastically supporting the second electrode body 312.

In an embodiment, one surface of the vibrator 301 may be supported by the first electrode body 311, and the other surface of the vibrator 301 may be supported by the support structure 325. The other surface of the vibrator 301 contacting the support structure 325 may be pressed by the support structure 325. Accordingly, it is possible to prevent the vibrator 301 from being out of position or damaged due to the vibration generated by the vibrator 301.

In an embodiment, the cartridge substrate 310 may be positioned inside the second housing 205b. For example, the cartridge substrate 310 may be spaced apart from the vibrator 301 and electrically connected to the vibrator 301 through the first electrode body 311 and the second electrode body 312. The cartridge substrate 310 may be electrically connected to an internal component (e.g., the main body substrate 335 of FIG. 6a) of the main body 250 of the aerosol generating device 200.

In an embodiment, the cartridge substrate 310 may be electrically connected to the first electrode body 311 and the second electrode body 312 to supply a signal to the vibrator 301. The cartridge substrate 310 may be fastened to a portion of the first electrode body 311 surrounding the outer circumferential surface of the vibrator 301.

In an embodiment, as the cartridge substrate 310 is electrically connected to the vibrator 301 by the first electrode body 311 and the second electrode body 312 and is electrically connected to the main body 250 at the same time, the vibrator 301 may be electrically connected to an external power source of the cartridge 210 via the cartridge substrate 310 to receive power therefrom.

In an embodiment, the support assembly 320 may include a channel 350 that is open toward the second surface 301b of the vibrator 301 from the outside. The channel 350 may be a space through which a fluid flows, a space through which an infrared ray or light passes, or a simple open space.

In an embodiment, the channel 350 may be configured by a plurality of communicating openings 351, 352, and 353 formed in at least a portion of the plurality of components of the support assembly 320.

For example, the cartridge substrate 310 may include a first opening 351 facing the second surface 302b. The support structure 325 may include a second opening 352 formed to allow communication between the first opening 351 and the second surface 301b. The support plate 315 may include a third opening 353 formed to allow communication the first opening 351 and the second opening 352.

In an embodiment, the channel 350 may be a space configured such that the second surface 301b of the vibrator 301 is exposed to the outside such that the temperature of the vibrator 301 can be measured. The channel 350 will be described in detail with reference to FIG. 6b.

FIG. 6a is a cross-sectional view of the aerosol generating device 200 according to an embodiment, and FIG. 6b is an enlarged cross-sectional view of the aerosol generating device 200 according to an embodiment. Specifically, FIG. 6b is an enlarged view of the area P shown in FIG. 6a.

Referring to FIGS. 6a and 6b, the aerosol generating device 200 according to an embodiment may include the temperature sensor 330 and a lens 340.

The cartridge 210 inserted into the aerosol generating device 200, described below, may be the cartridge 210 including the vibrator assembly 300 according to the embodiments of FIGS. 4 to 5b, but is not limited thereto. Hereinafter, in describing the aerosol generating device 200 with the cartridge 210 inserted thereinto, the description provided above will not be repeated.

In an embodiment, the cartridge 210 may be detachably coupled to the cartridge fastening area 255 of the main body 250. The cartridge fastening area 255 may be a portion of the main body 250 to which the cartridge 210 is coupled. A securing member 255a may hold or secure the mouthpiece 223 in the closed position.

In an embodiment, the cartridge fastening area 255 may accommodate at least a portion of the cartridge 210. For example, the cartridge fastening area 255 may have a shape corresponding to that of at least a partial area of the cartridge 210 (e.g., a partial area of the housing 205), so that at least a partial area of the mouthpiece 223 of the cartridge 210 and a cartridge body (e.g., the cartridge body 221 of FIG. 4) may be accommodated or inserted therein.

In an embodiment, a first magnetic body (not shown) may be included in at least one area of the cartridge body 221 of the cartridge 210, and a second magnetic body (not shown) may be included in at least one area of the cartridge fastening area 255 of the main body 250. For example, the first magnetic body (not shown) may be disposed on a lower surface of the cartridge body 221, and the second magnetic body (not shown) may be disposed on a bottom surface of the cartridge fastening area 255 of the main body 250 facing the lower surface of the inserted cartridge body 221. Accordingly, the cartridge 210 placed at a predetermined position in the cartridge fastening area 255 may be coupled to the main body 250 by the magnetic force.

In an embodiment, the aerosol generating device 200 may include the securing member 255a for holding the mouthpiece 223 in a predetermined position. For example, the main body 250 may include the securing member 255a for holding the closed mouthpiece 223 in the closed position. The securing member 255a may be positioned in a portion of the cartridge fastening area 255 where the mouthpiece 223 in the closed position is stored.

In an embodiment, when closing the mouthpiece 223, the user may apply an external force to move the mouthpiece 223 from the open position to the closed position. When the mouthpiece 223 is moved to the closed position, the securing member 255a may provide a holding force to the mouthpiece 223 to hold the mouthpiece 223 in the closed position. For example, the securing member 255a may provide magnetic, elastic, and/or frictional forces to one end of the mouthpiece 223 to hold the mouthpiece 223 in the closed position.

In an embodiment, when opening the mouthpiece 223, the user may apply an external force to the mouthpiece 223 to move the mouthpiece 223 from the closed position to the open position. For example, when the user presses the other side of the mouthpiece 223 with a predetermined force or stronger, the mouthpiece 223 may be released from the securing member 255a, and the mouthpiece 223 may rotate from the closed position to the open position.

In an embodiment, one end of the securing member 255a and one end of the mouthpiece 223 may each include a magnetic body having an opposite polarity. Accordingly, when one end of the mouthpiece 223 is brought closer to the closed position by a predetermined distance, the mouthpiece 223 may be pulled by the magnetic force and held in the closed position.

In an embodiment, the aerosol generating device 200 may further include an inhalation detection sensor (not shown). The inhalation detection sensor (not shown) may sense whether the user inhales through the aerosol generating device 200, by detecting a change in internal pressure or an airflow of the aerosol generating device 200.

In an embodiment, the inhalation detection sensor (not shown) may be positioned anywhere in the cartridge 210 or the main body 250. Since the cartridge 210 may be a consumable that is replaced when the aerosol generating material stored therein is used up, the inhalation detection sensor (not shown) may be preferably positioned in the main body 250.

In an embodiment, the inhalation detection sensor (not shown) may be positioned adjacent to the cartridge fastening area 255 of the main body 250. For example, the inhalation detection sensor (not shown) may be positioned in one area of the cartridge fastening area 255 adjacent to the outer circumferential surface of the cartridge 210 coupled to the main body 250. As another example, the inhalation detection sensor (not shown) may be positioned in one area of the main body 250 facing the outer circumferential surface of the housing 205 of the cartridge 210 coupled to the main body 250.

In an embodiment, since the outside air may be introduced into the aerosol generating device 200 through a fine gap between the main body 250 and the cartridge 210 which are coupled to each other, the inhalation detection sensor (not shown) may be disposed adjacent to an area where the outside air flows, to more accurately detect a change in internal pressure or an airflow of the main body 250.

In an embodiment, the main body 250 may include at least one inlet 251 through which air outside the main body 250 may be introduced into the main body 250 and the cartridge 210. The inlet 251 may communicate with the inside of the cartridge 210 through at least one opening formed in the cartridge 210 (e.g., the sensor hole 207).

In an embodiment, the outside air introduced into the cartridge 210 through the inlet 251 may flow into the atomization space 257 along the aerosol flow path 224. The airflow in the aerosol flow path 224 may be sharply bent at a portion where the traveling direction changes.

For example, the traveling path of the airflow may sharply change in a portion where the atomization space 257 is positioned. This may increase the time the airflow stays in the atomization space 257 and improve the possibility of generating vortices. As a result, the outside air introduced into the atomization space 257 may be easily mixed with the generated aerosol.

In an embodiment, the atomization space 257 may be positioned in a central portion of the first housing 205a of the cartridge 210. The outside air introduced into the cartridge 210 through the inlet 251 formed in the main body 250 may flow into the atomization space 257 along the aerosol flow path 224. The airflow flowing in the aerosol flow path 224 may be sharply bent at a portion where the traveling direction changes.

For example, when the user brings the mouth into contact with the mouthpiece 223 and performs an inhalation motion, the internal pressure of the cartridge 210 may become lower than atmospheric pressure, and the outside air may flow through the inlet 251 of the main body 250 into the cartridge 210.

In an embodiment, the aerosol flow path 224 may be connected to the inlet 251, the atomization space 257 where aerosol is generated, and the intake 225. The aerosol flow path 224 may be formed by at least one component (e.g., the first housing 205a, the second housing 205b, and the mouthpiece 223) of the cartridge 210. Alternatively, as a modified example, at least a portion of the aerosol flow path 224 may be formed as a tube inserted into the housing 205.

In an embodiment, the airflow may move in a forward direction from the inlet 251 through the atomization space 257 toward the intake 225. In this case, the “forward direction” may refer to a direction in which airflow moves when the user inhales through the mouthpiece 223. For example, the forward direction may include a direction from the inlet 251 toward the atomization space 257 and a direction from the atomization space 257 toward the intake 225.

In an embodiment, the lens 340 may be disposed on one surface (e.g., a bottom surface) of the cartridge fastening area 255. In an embodiment, the lens 340 may be disposed to face a partial area of the cartridge 210 (e.g., the sensor hole 207 of the cartridge 210) while the cartridge 210 is coupled to the main body 250.

In an embodiment, the temperature sensor 330 may be positioned to face the cartridge fastening area 255 in the main body 250. The temperature sensor 330 may be include an infrared sensor.

For example, the temperature sensor 330 may include a light emitter that emits infrared rays and a light receiver that detects infrared rays returning after reflected from a target object. The temperature sensor 330 may sense the temperature of the target object through the amount of light detected by the light receiver.

For example, the temperature sensor 330 according to an embodiment may not include a light emitter but include a light receiver. The light receiver may sense the temperature of the target object through the wavelength of light emitted and/or reflected from the target object. However, this is an exemplary description of driving the temperature sensor 330 which is an infrared sensor according to an embodiment. The temperature sensor 330 is not limited thereto in practical implementation and may be implemented in various manners.

In an embodiment, the temperature sensor 330 may be connected to the main body substrate 335 (e.g., printed circuit board). Alternatively, the temperature sensor 330 may be mounted or disposed on the main body substrate 335. The main body substrate 335 may be positioned inside the main body 250 and may control the overall driving of the aerosol generating device 200.

In an embodiment, the main body substrate 335 may be a controller (e.g., the controller 110 of FIGS. 1 or 2) of the aerosol generating device 200, or may be part thereof. For example, the controller 110 may include the cartridge substrate 310 and the main body substrate 335. The cartridge substrate 310 and the main body substrate 335 may be electrically and/or communicatively connected to each other.

In an embodiment, the main body substrate 335 may be connected to the inside of the cartridge body 221 of the cartridge 210 through a cable or wire, and may be connected to the cartridge substrate 310 of the cartridge 210. Since the cartridge substrate 310 of the cartridge 210 is in electrical contact with the vibrator 301, the vibrator 301 may be electrically connected to the main body 250 via the cartridge substrate 310. The driving of the vibrator 301 may be controlled by the main body substrate 335, and the vibrator 301 may receive power from a battery (e.g., the battery 140 of FIGS. 1 or 2) of the main body 250.

In an embodiment, the temperature sensor 330 may sense the temperature of the second surface 301b of the vibrator 301. The vibrator 301 may be driven to generate vibration and thereby emit heat, and when the vibrator 301 is overheated, the vibrator 301 or peripheral parts may be damaged or the performance of the vibrator 301 may decrease. In this regard, the temperature sensor 330 may substantially directly sense the temperature of the second surface 301b of the vibrator 301, and the controller may control the driving of the vibrator 301 based on the sensing result.

In an embodiment, when the vibrator 301 is heated, the temperature of the central area of the second surface 301b of the vibrator 301 may first change. In order for the temperature sensor 330 to sense the temperature of the central area of the second surface 301b of the vibrator 301, it is desirable that obstacles between the temperature sensor 330 and the vibrator 301 are removed or minimized, and a path between the temperature sensor 330 and the vibrator 301 may be shortened. Also, a path of light between the temperature sensor 330 and the vibrator 301 may be controlled. As such, the temperature sensor 330 may quickly and accurately detect a change in the temperature of the vibrator 301.

Hereinafter, a plurality of embodiments of the aerosol generating device 200 will be described based on the above description of the aerosol generating device 200 and the cartridge 210. For example, the plurality of embodiments may improve the performance of the temperature sensor 330 or improve the performance, durability, and/or space efficiency of the aerosol generating device 200. In practical implementation, the embodiments may be implemented independently of each other, or two or more of the embodiments may be implemented simultaneously.

In an embodiment, when at a great distance from the target object, the temperature sensor 330 which is an infrared sensor may have a low accuracy of the detection result and have difficulties in quickly detecting a temperature change. In an embodiment, the lens 340 may be positioned between the sensor hole 207 and the temperature sensor 330. The lens 340 may widen the sensing range of the temperature sensor 330 (or the angle of view of the temperature sensor 330 which is an infrared sensor).

For example, the lens 340 may condense light emitted from the temperature sensor 330 and control an optical path toward the second surface 301b of the vibrator 301. Also, the lens 340 may condense light reflected from the vibrator 301 (or light returning after emitted from the temperature sensor 330 and then reflected from the vibrator 301) and control an optical path toward the temperature sensor 330. Through the lens 340, the temperature sensor 330 may accurately and quickly sense a change in the temperature of the vibrator 301.

In an embodiment, an area between the lens 340 and the channel 350 may form an open space through the sensor hole 207. Since the channel 350 extends to the second surface 301b of the vibrator 301, an area between the lens 340 and the second surface 301b of the vibrator 301 may be open. Since there is no obstacle between the lens 340 and the second surface 301b, air or light may be transmitted from the second surface 301b directly to the lens 340, and the temperature sensor 330 may quickly and accurately sense the temperature of the second surface 301b.

In an embodiment, the channel 350 may include the first opening 351 of the cartridge substrate 310 and the second opening 352 of the support structure 325. The first opening 351 may be formed at a position to face the lens 340, and the second opening 352 may be formed to allow communication between the first opening 351 and the second surface 301b, such that the first opening 351 and the second opening 352 may form the channel 350. As such, the vibrator assembly 300 may expose the second surface 301b of the vibrator 301 to the outside, and the channel 350 may be formed relatively easily and efficiently.

In an embodiment, the second electrode body 312 may be positioned in the second opening 352 of the support structure 325. The second electrode body 312 may be formed of an elastic material with the center open so as to overlap at least a portion of the second opening 352. In the drawings, the second electrode body 312 is shown as a spring structure, but is not limited thereto in practical implementation. The second electrode body 312 may be implemented with various types of elastic materials having an opening which overlaps the second opening 352.

In an embodiment, the second electrode body 312 may not only supply power to the vibrator 301 and provide an elastic force with respect to the vibration of the vibrator 301, but also form part of the channel 350 so that the second surface 301b of the vibrator 301 may be exposed to the outside.

In an embodiment, a path from the temperature sensor 330 to the second surface 301b may be formed to be the shortest distance. For example, the second surface 301b of the vibrator 301, the channel 350, the lens 340, and the temperature sensor 330 may be arranged on one straight line. In this case, there is no component other than the lens 340 between the temperature sensor 330 and the second surface 301b, and the path from the temperature sensor 330 to the second surface 301b may be formed to be short. Accordingly, the temperature sensor 330 may quickly and accurately sense the temperature of the second surface 301b.

In an embodiment, the lens 340 may be disposed apart from each of the vibrator assembly 300 and the temperature sensor 330 by a predetermined distance. The sensor hole 207 may be formed in an area between the lens 340 and the vibrator assembly 300, and the area between the lens 340 and the vibrator assembly 300 may be an open space. Also, an area between the lens 340 and the temperature sensor 330 may be an open space.

For example, the cartridge fastening area 255 of the main body 250 may include a lens hole 333. The lens hole 333 may have a recessed structure in which the lens 340 is seated, and may include an opening. The lens hole 333 may be formed in the area between the lens 340 and the temperature sensor 330. In a state where the temperature sensor 330 and the lens 340 are spaced apart from each other, the lens hole 333 may form an open space therebetween.

In an embodiment, a space between the temperature sensor 330 and the lens 340 and a space between the lens 340 and the vibrator assembly 300 may be an open space, and thus the lens 340 may directly face the second surface 301b of the vibrator 301 through the channel 350. As such, only the lens 340 may be disposed between the temperature sensor 330 and the vibrator 301 to condense light of the temperature sensor 330, and thus the temperature sensor 330 may quickly and accurately sense the temperature of the second surface 301b.

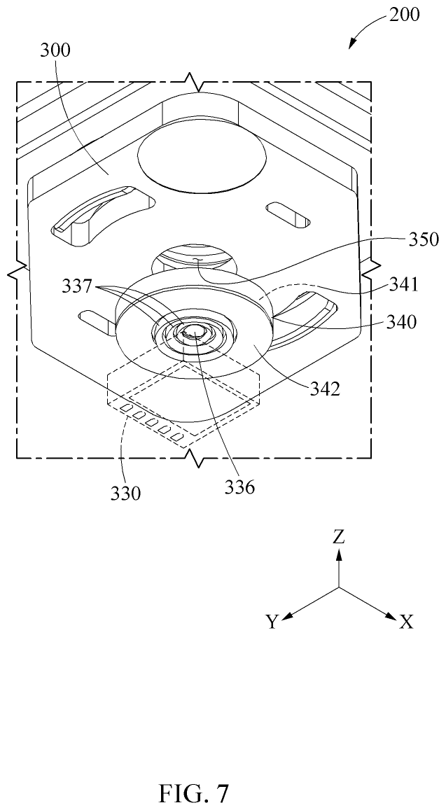

FIG. 7 is a rear perspective view of the aerosol generating device 200 according to an embodiment.

Referring to FIG. 7, the lens 340 according to an embodiment may include a first lens surface 341 and a second lens surface 342.

In an embodiment, the lens 340 may condense light traveling from the vibrator assembly 300 toward the temperature sensor 330 to be concentrated on the temperature sensor 330.

For example, the lens 340 may condense light reflected from the vibrator 301 and proceeding to the temperature sensor 330.

In an embodiment, the lens 340 may include the first lens surface 341 and the second lens surface 342 opposite to the first lens surface 341. The first lens surface 341 may be a surface facing the vibrator assembly 300, specifically, the second surface 301b of the vibrator 301 or the channel 350, and the second lens surface 342 may be a surface facing the temperature sensor 330.

In an embodiment, the first lens surface 341 and the second lens surface 342 may be implemented in various shapes. For example, the lens 340 may be a condensing lens such as a Fresnel lens or a convex lens. Alternatively, the lens 340 may be formed by combining a plurality of lens segments and, for example, may be configured to allow light having a wavelength of 2 to 14 micrometers to pass.

In an embodiment, the lens 340 may include one or more condensing areas 336 and 337. For example, the lens 340 may include at least one of a first condensing area 336 and a second condensing area 337.

In an embodiment, the one or more condensing areas 336 and 337 may be formed on at least one of the first lens surface 341 and the second lens surface 342. As shown in FIGS. 6a and 6b, the first lens surface 341 exposed to the cartridge fastening area 255 may be substantially flat. The first lens surface 341 implemented to flat may have a relatively high rigidity, and may prevent the lens 340 from being damaged during the process of fastening and unfastening the cartridge 210. Also, the first lens surface 341 implemented to be flat may prevent the transmittance of the lens 340 from being lowered as a foreign substance is stuck in a curved area.

In an embodiment, the first condensing area 336 may be formed with a predetermined curvature, so as to condense light traveling from the first lens surface 341 to the second lens surface 342 (and/or so as to condense light traveling from the second lens surface 342 to the first lens surface 341). For example, the first condensing area 336 may be implemented as a convex lens.

In an embodiment, the first condensing area 336 may be formed on the second lens surface 342 of the lens 340 and, for example, may be formed adjacent to the center of the second lens surface 342. In the drawings, the first condensing area 336 is illustrated as being partially formed only in the center of the second lens surface 342, but is not limited thereto in practical implementation. In an embodiment, the first condensing area 336 may be formed in substantially the entirety or large portion of the area of the second lens surface 342.

In an embodiment, the second condensing area 337 may be formed to protrude from the second lens surface 342 and have an inclined distal portion, so as to condense light traveling from the first lens surface 341 to the second lens surface 342 (and/or so as to condense light traveling from the second lens surface 342 to the first lens surface 341).

For example, the second condensing area 337 may be formed such that the top surface of the protrusion may be edged or curved in a direction toward the center of the lens 340. Alternatively, the second condensing area 337 may be formed such that its inner surface facing the center of the lens 340 has a smaller height than its outer surface facing the outside of the lens 340, such that the top surface may be inclined toward the center of the lens 340. The second condensing area 337 is not limited thereto, and may be implemented in various three-dimensional structures to change a path of light passing through the lens 340.

In an embodiment, the second condensing area 337 may have a structure that protrudes while surrounding the center of the second lens surface 342. The second condensing area 337 may condense light toward the center of the second lens surface 342, thereby increasing the amount of light reflected from the temperature sensor 330 and improving the temperature detection of the temperature sensor 330.

In an embodiment, the second condensing area 337 may be formed in plurality. The plurality of second condensing areas 337 may be arranged around the center of the second lens surface 342, spaced apart from each other at predetermined intervals in a radial direction. The plurality of condensing areas 336 and 337 may condense light more intensively than the structure of a typical lens. In FIG. 7, the plurality of second condensing areas 337 are illustrated as a structure surrounding the first condensing area 336, but are not limited thereto in practical implementation. The lens 340 may include a plurality of second condensing areas 337 without a first condensing area 336, and the plurality of second condensing areas 337 may be formed in substantially the entirety or large portion of the area of the second lens surface 342.

The structure of the lens 340 described above is described as an example only to improve light condensing performance and embodiments are not limited thereto in practical implementation. The aerosol generating device 200 may dispose the lens 340 between the temperature sensor 330 and the vibrator 301 in various structures and arrangements, such that the temperature sensor 330 may accurately and quickly sense a change in the temperature of the vibrator 301.

A number of embodiments have been described above. Nevertheless, it should be understood that various modifications may be made to these embodiments. For example, suitable results may be achieved if the described techniques are performed in a different order, and/or if components in a described system, architecture, device, or circuit are combined in a different manner, and/or replaced or supplemented by other components or their equivalents. Accordingly, other implementations are within the scope of the following claims.

1. An aerosol generating device comprising:
a main body comprising a cartridge fastening area;
a cartridge detachably fastened to the cartridge fastening area; and
a temperature sensor positioned to face the cartridge fastening area in the main body and including an infrared sensor,
wherein the cartridge comprises:
a reservoir configured to store an aerosol generating material;
a transmission member configured to receive the aerosol generating material from the reservoir;
a vibrator assembly configured to atomize the aerosol generating material by vibrating the transmission member;
a housing configured to accommodate the reservoir, the transmission member, and the vibrator assembly and comprising a sensor hole formed at a position opposite to the temperature sensor; and
a lens positioned between the sensor hole and the temperature sensor.

2. The aerosol generating device of claim 1, wherein
the vibrator assembly comprises:
a vibrator comprising a first surface facing the transmission member and a second surface opposite to the first surface; and
a support assembly configured to support the vibrator and comprising a channel that is open from the lens to the second surface of the vibrator.

3. The aerosol generating device of claim 2, wherein
the channel is an open space such that the lens directly faces the second surface of the vibrator.

4. The aerosol generating device of claim 2, wherein
the second surface of the vibrator, the channel, the lens, and the temperature sensor are arranged on one straight line.

5. The aerosol generating device of claim 2, wherein
the support assembly comprises:
a cartridge substrate spaced apart from the vibrator and comprising a first opening formed at a position opposite to the lens; and
a support structure positioned between the cartridge substrate and the second surface of the vibrator and comprising a second opening communicating with the first opening and the second surface,
wherein the channel comprises the first opening and the second opening.

6. The aerosol generating device of claim 5, wherein
the support assembly comprises:
a first electrode body configured to contact the first surface of the vibrator; and
a second electrode body configured to contact the second surface of the vibrator and provide an elastic force onto the second surface.

7. The aerosol generating device of claim 6, wherein
the second electrode body is positioned in the second opening of the support structure and comprises an elastic material having an open center which overlaps at least a portion of the second opening.

8. The aerosol generating device of claim 1, wherein
the lens is spaced apart from the vibrator assembly and the temperature sensor, and
an area between the lens and the vibrator assembly and an area between the lens and the temperature sensor are each an open space.

9. The aerosol generating device of claim 1, wherein
the lens is configured to condense light traveling from the vibrator assembly toward the temperature sensor to be concentrated on the temperature sensor.

10. The aerosol generating device of claim 1, wherein
the lens comprises:
a first lens surface facing the vibrator assembly; and
a second lens surface opposite to the first lens surface and facing the temperature sensor.

11. The aerosol generating device of claim 10, wherein
the lens comprises a first condensing area formed to be curved with a predetermined curvature, so as to condense light traveling from the first lens surface to the second lens surface.

12. The aerosol generating device of claim 11, wherein
the first condensing area is formed on the second lens surface, and
the first lens surface is substantially flat.

13. The aerosol generating device of claim 10, wherein
the lens comprises a second condensing area formed to protrude from the second lens surface and have an inclined distal portion, so as to condense light traveling from the first lens surface to the second lens surface.

14. The aerosol generating device of claim 13, wherein
the second condensing area surrounds a center of the second lens surface.

15. The aerosol generating device of claim 13, wherein
the second condensing area is formed in plurality, and
a plurality of second condensing areas are arranged around a center of the second lens surface and spaced apart from each other at a predetermined interval in a radial direction.
